(19) United States
(12) Patent Application Publication
(10) Pub. No.: US 2024/0270471 A1
(43) Pub. Date: Aug. 15, 2024

(54) SHREDDED RECYCLED CARDBOARD FILLED PACKAGING CUSHION AND METHOD OF MAKING PACKAGING CUSHION USING RECYCLED CARDBOARD MATERIAL

(71) Applicant: Spraying Systems Co., Wheaton, IL (US)

(72) Inventor: Peter Bramsen, Wheaton, IL (US)

(21) Appl. No.: 18/438,833

(22) Filed: Feb. 12, 2024

Related U.S. Application Data
(60) Provisional application No. 63/444,609, filed on Feb. 10, 2023.
(60) Provisional application No. 63/450,856, filed on Mar. 8, 2023.

(51) Int. Cl. B65D 81/05; B31D 5/00

(52) U.S. Cl. CPC B65D 81/051; B31D 5/0078; B31D 2205/0058; B65D 2581/053

(57) ABSTRACT

A packaging cushion includes a pouch that defines a hollow interior space. The pouch is made of a paper material. A fill material is contained within the hollow interior space of the pouch. The fill material consists of loose, used packaging material.

### CROSS-REFERENCE TO RELATED APPLICATIONS

This application is a non-provisional of U.S. Provisional Application Ser. No. 63/444,609 filed Feb. 10, 2023, entitled “SHREDDED RECYCLED CARDBOARD FILLED PACKAGING CUSHION AND METHOD OF MAKING PACKAGING CUSHION USING RECYCLED CARDBOARD MATERIAL,” and U.S. Provisional Application Ser. No. 63/450,856 filed Mar. 8, 2023 the contents of which are expressly incorporated herein by reference in their entirety, including any references therein.

### BACKGROUND OF THE INVENTION

Many industries use very high volumes of packaging materials. These packaging materials include cardboard boxes as well as cushions, separators and other dunnage materials used inside of cardboard boxes to fill voids or otherwise provide shock absorption in order to protect items being shipped. For example, inflatable plastic air cushions are one common packaging material used inside of boxes and other shipping containers to protect items being shipped. Air cushions offer many advantages including low cost, ease of use and low weight. However, one significant disadvantage of air cushions is that they lose all effectiveness in terms of both filling space and shock absorption if punctured or the air otherwise leaks out of the cushion. Additionally, providing air cushions for packaging does impose additional monetary and environmental costs. In particular, air cushions utilize plastic air bags and require specialized inflating equipment that impose additional costs. Moreover, used air cushions can be difficult to deflate and recycle. Other types of packaging material pose similar problems. For example, styrofoam packaging materials are subject to the build-up of static electricity that can cause such materials to stick to things, making them difficult to dispose of. Styrofoam packaging materials also raise serious environmental concerns as they can be very slow to degrade, and if disposed improperly, can leach chemicals into the environment harming water sources.

Many companies not only use packaging materials to ship their own products, but also receive parts and other products in such packaging materials in very high volumes. As a result, many companies must find ways to dispose of large quantities of used packaging materials. This used packaging material can include a large amount of used corrugated cardboard boxes. These used corrugated cardboard boxes generally have limited reuse potential by the recipient of the package. One way in which the corrugated cardboard can be reused is by shredding the cardboard and using the shredded cardboard as dunnage material in the shipping of other products. However, shredded cardboard is a poor dunnage material as can lead to the accumulation of cardboard dust on the products being shipped. Shredded cardboard dunnage material can also be visually unappealing particularly if it is created using damaged cardboard or cardboard that is marked with information that is inapplicable to the product being shipped. Shredded cardboard dunnage material is also messy and difficult for the package recipient to dispose of. While used corrugated cardboard boxes can be broken down and sent out for recycling instead of being reused, package recipients typically receive little or no compensation from recyclers for the used boxes.

### OBJECTS OF THE INVENTION

In view of the foregoing, a general object of the present invention is to provide a more environmentally sustainable packaging material.

A more specific object of the present invention is to provide a packaging cushion using recycled packaging materials.

Another object of the present invention is to provide a method for efficiently recycling used packaging material into new packaging cushions.

A further object of the present invention is to provide a packaging material that is inexpensive to manufacture.

Another object of the present invention is to provide a packaging cushion that is durable and maintains its functionality even if punctured or otherwise damaged.

A further object of the present invention is to provide a packaging material that does not contaminate the items being packaged.

A related object of the present invention is to provide a packing material that is visually appealing.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWINGS

FIG. 1 is a perspective view of an exemplary embodiment of a packaging cushion filled with shredded recycled corrugated cardboard material according to the present invention.

FIG. 2 is a cross-sectional view of the packing cushion of FIG. 1.

FIG. 3 is a block diagram of an exemplary method for making a packaging cushion using shredded, recycled corrugated cardboard according to the present invention.

FIG. 4 is a schematic diagram of exemplary process machinery for performing the method of FIG. 3.

### DETAILED DESCRIPTION OF THE INVENTION

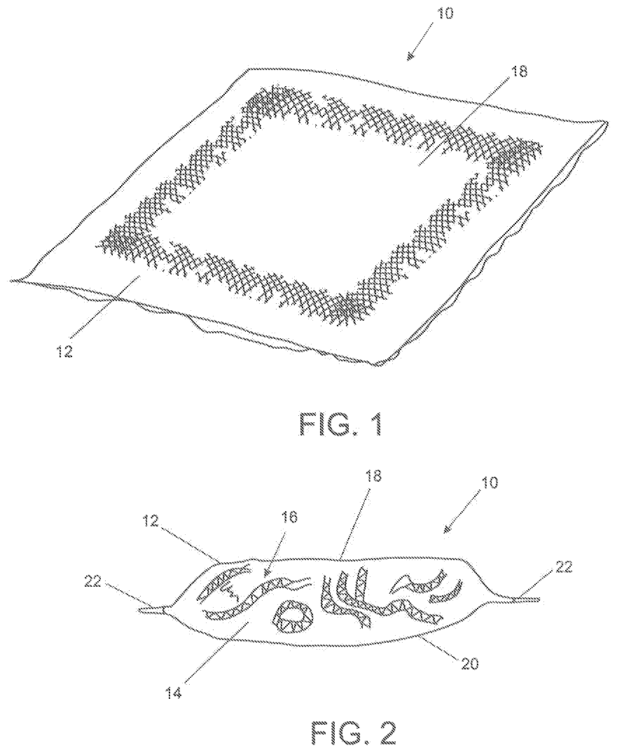

Referring to FIGS. 1 and 2 of the drawings, there is shown an exemplary embodiment of a packaging cushion 10 according to the present invention. While the illustrated packaging cushion 10 is substantially rectangular in shape, the packaging cushion 10 of the present invention can be any shape, size or configuration that has utility in filling voids and/or absorbing shock in a box or other type of container used for transporting goods.

The packaging cushion 10 generally consists of a pouch 12 that defines a hollow interior space 14 (see FIG. 2) that contains a fill material 14, the composition of which is described in greater detail below. The pouch 12 is preferably formed from a paper material. One example of a suitable paper material is kraft paper, which offers good durability and strength while being environmentally friendly. Preferably, the paper material has a weight of between approximately 20 lbs. and approximately 60 lbs. According to one embodiment, the paper material has a weight between approximately 30 lbs. and approximately 50 lbs. The paper material can be any desired color, although brown kraft paper offers the advantages of being visually appealing, affordable and environmentally friendly.

In the illustrated embodiment, as shown in FIG. 2, the pouch 12 includes top and bottom sheets 18, 20 of paper that are joined together at or near their edges in a manner that defines the hollow interior space 14. The top and bottom sheets 18, 20 of paper may be joined together by any suitable method. For example, the top and bottom sheets 18, 20 may be joined together using an adhesive material 22. If an adhesive is used, according to one embodiment, at least one side of one or both of the top and bottom sheets 18, 20 may be pre-coated with an adhesive such as a co-adhesive material that will bond to itself upon curing or drying. Alternatively, an adhesive tape may be used to secure the top and bottom sheets 18, 20 together. Another method that could be used to secure the top and bottom sheets 18, 20 together is staples applied about the perimeter of the sheets 18, 20. Yet another method for joining the top and bottom sheets 18, 20 is crimping.

Instead of forming the pouch 12 from separate top and bottom sheets 18, 20 such as shown in FIGS. 1 and 2, a single paper sheet could be used to form the pouch 12. For example, a single sheet of paper could be formed into an envelope-like configuration that defines the pouch using a combination of folds and joints secured with adhesive. Other methods for forming the paper pouch 12 could also be used.

To provide more environmentally sustainable packaging, the fill material 16 contained within the hollow interior space 14 of the pouch 12 consists of loose, used packaging materials. In this context, used packaging materials means packaging materials that have already been used once for their originally intended purpose. According one preferred embodiment, the fill material 16 consists of used corrugated cardboard (i.e., corrugated cardboard that has been used at least once for its originally intended purpose) that has been shredded or broken into smaller pieces. Used corrugated cardboard is a material that is relatively inexpensive and in plentiful supply. For those that send and receive high volumes of packages, the use of shredded used corrugated cardboard as the fill material 16 can provide a more efficient usage of used corrugated cardboard because it allows such entities to recycle their own used packaging material into packaging cushions 10 that, in turn, can be used when packaging their own goods. Other used packaging materials that could be used as the fill material 16 for the packaging cushions of the present invention include used biodegradable packaging peanuts. These other used packaging materials may also be shredded or otherwise broken down to provide a more appropriately sized fill material 16 for the pouch 12.

The use of a paper pouch 12 offers the advantages of both containing and hiding the fill material 16. Accordingly, used corrugated cardboard may be used as the fill material 16 regardless of its appearance, including any markings from other manufacturers or damage to the cardboard. Moreover, the paper pouch 12 effectively contains the shredded cardboard and other packaging material and there is no need to bind the fill material 16 together in any way. Thus, the paper pouch 12 allows the used corrugated cardboard material to be reused as dunnage material, but as compared to loose shredded cardboard, in a manner that prevents the shredded packaging material from contaminating goods being shipped and messy spills of shredded packaging materials when packing and unpacking boxes or other shipping containers. The paper pouch 12 is also durable and because shredded used packaging materials are used as the fill material 16 as opposed to air, the packaging cushions 10 of the present disclosure will retain their shape and shock absorbency even if the paper pouch is punctured.

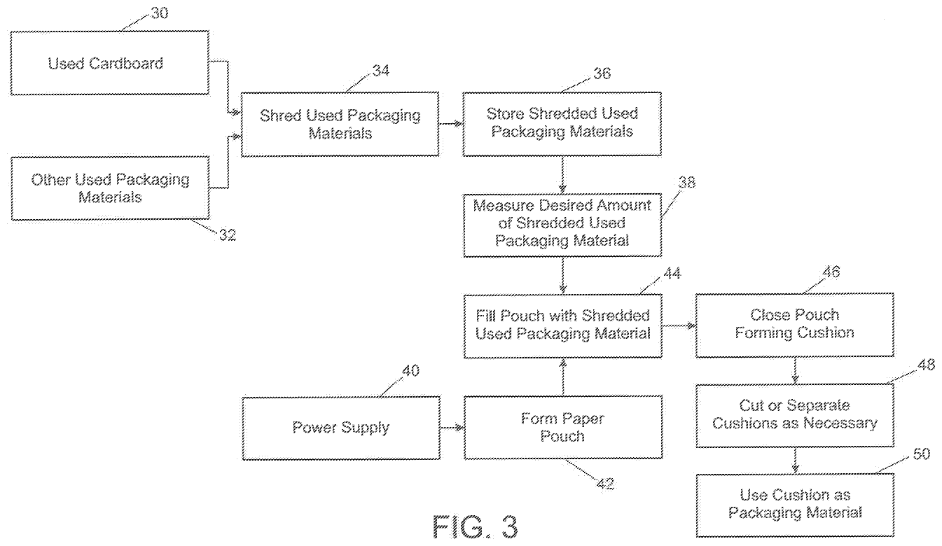

Referring to FIG. 3 of the drawings, there is shown an exemplary method of recycling used packaging materials into packaging cushions 10 that can be used as a new dunnage material for shipping goods. In a first step 30 associated with the creation of the fill material 16, used cardboard and/or, in step 32 ,other used packaging materials (e.g., biodegradable packaging peanuts) are collected. Next, the used packaging materials are shredded to create the fill material for the packaging cushions in step 34. In some embodiments, the fill material 16 may also include pre-shredded packaging materials. The shredding of the used packaging material may be performed on-site (i.e., at the location where the packaging cushions of the present disclosure will be used) or off-site. Performing the collecting of the used packaging materials (steps 30, 32) and the shredding of the used packaging materials (step 34) on site has several advantages including allowing for the efficient re-use of a user's own used packaging materials. If necessary, the shredded used packaging material may be stored until needed for filling a pouch. As will be appreciated, there may be instances in which there is no need for intermediate storage of the shredded packaging material and instead such material is used immediately in filling a pouch.

In a first step 40 associated with the forming of the paper pouch bodies, paper is obtained from a paper supply. In one example, as noted above, the paper supply make include one or more rolls of kraft paper. For ease of delivery of the paper, the one or more rolls of kraft paper may be arranged on corresponding spools. The paper is formed into pouches 12 in step 42. The formation of the paper into pouches 12 may be a continuous operation or the pouches 12 may be formed intermittently on an as needed basis.

Once the paper pouches 12 have been formed and the fill material 16 of shredded used packaging material has been produced, the paper pouches may be filled with the fill material in step 44. The filling operation may include a preceding step 38 of measuring a desired amount of the shredded used packaging fill material 16. This measurement may be performed based on a weight of the fill material, a volume of the fill material or some other similar method. The desired amount of shredded used packaging fill material 16 may depend on the desired size and/or density of the finished packaging cushion 10. Once filled, the next step 46 can comprise closing the pouch 12 thereby forming a packaging cushion 10 according to the present invention. As detailed above, the closing of the pouch 12 may be performed in any suitable manner. Some examples of methods for closing the pouch 12 include use of a separately applied adhesive, tape, crimping or staples. As also noted above, the paper from the paper supply may be pre-coated with a co-adhesive material that bonds to itself upon curing or drying. If a co-adhesive material is used the step of closing the pouch 12 to form the packaging cushion 10 may include curing or drying. In some alternative embodiments, step 46 may include closing, but not sealing the pouch 12. In such cases, the sealing step may be performed at a later time.

In step 48, the packaging cushions 10 are cut or separated as necessary. In some cases, the cutting or separating of the cushions 10 from one another is performed immediately after the cushions are formed and closed. In other instances, the cushions 10 may be maintained in a multi-cushion array that may be cut or separated later such as at the time of use. If the cushions 10 are configured for later separation into individual cushions, it may be desirable to have perforations in the paper pouches 12 that facilitate separation of the packaging cushions 10. There also may be instances in which the packaging cushions 10 are maintained in a multi-cushion array for use. Moreover, in some cases, the step 48 of cutting or separating of the cushions 10 can include a selection of a desired size for the packaging cushion. After the packaging cushions 10 have been cut or separated as necessary, they are ready for final use in step 50. Prior to use, the packaging cushions may be stored until needed.

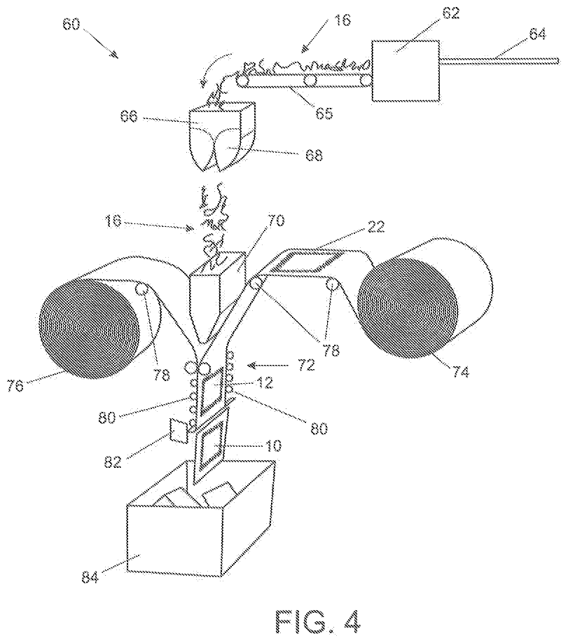

Exemplary process machinery 60 for producing the packaging cushions 10 of the present invention is shown in FIG. 4. The process machinery 60 includes a shredder 62 configured for shredding used cardboard packaging material (the un-shredded cardboard packaging material is referenced as 64 in FIG. 4). The used cardboard packaging material 64 may be fed to the shredder by hand or alternatively a conveyor may be used. From the shredder 62, the now shredded used packaging fill material 16 may be directed to a hopper 66 by, in this case, a fill conveyor 65. In the illustrated embodiment, the shredded packaging material 16 is fed via gravity to an open upper end of the hopper 66, although different configurations for the fill material feed and the hopper could also be used. The hopper 66 may be configured to collect a desired amount of shredded packaging material for use in filling a pouch prior to directing the shredded packaging fill material to an empty pouch. To this end, the hopper 66 may have a discharge door 68 movable between open and closed positions and the hopper 66 may be configured to weigh or otherwise measure the desired amount of shredded packaging fill material. When the desired amount of fill material 16 is present in the hopper 66, the hopper discharge door 68 opens to direct the shredded cardboard packaging fill material 16 into a fill chute 70. Again, the in the illustrated embodiment, the desired amount of shredded cardboard material is directed via a gravity through the discharge door 68 of the hopper 66 and into the fill chute 70, although other conveying methods, such as a belt conveyor, could also be used.

The illustrated fill chute 70 is configured and oriented to direct the desired amount of shredded used packaging fill material 16 into a pouch-forming zone 72. This again is accomplished in this case via gravity. Two rolls 74, 76 of kraft paper are supported on spindles and feed rollers 78 are provided that direct the paper from the kraft paper rolls 74, 76 to the pouch-forming zone 72. The kraft paper rolls 74, 76 and associated feed rollers 78 are supported such that one kraft paper roll provides the paper for a first side of the pouch 12 and the other kraft paper roll provides the paper for the opposing second side of the pouch 12. In the illustrated embodiment, adhesive 22 is applied to at least one side of the kraft paper. This adhesive may be applied in a rectangular outline as the paper unfurls from the kraft paper roll 74. Adhesive may similarly be applied to one or both of the paper feeds. If a co-adhesive is used, the kraft paper rolls 74, 76 may be pre-coated with the co-adhesive material thereby eliminating the need for adhesive application in the paper feed.

In the pouch-forming zone 75, the paper for the two sides of the pouch 12 is brought together into back-to-back relation by forming rollers 80. These forming rollers 80 may be configured to seal or otherwise close the pouches 12 using the adhesive or co-adhesive at three edges of the pouch 12 through the application of pressure while the fourth edge of the pouch facing the fill chute 70 remains open. In this case, the shredded used packaging fill material 16 is directed via gravity from the fill chute 70 through the open fourth edge of the pouch 12 and into the pouch interior. After the pouch 12 has been filled, the fourth edge of the pouch is sealed such as through pressure applied by a roller. Once closed, the completed packaging cushion 10 may be cut or otherwise separated from the trailing pouch 12 at a cutting station 82 and collected in a collection bin 84. Other arrangements may be provided for cutting or separating pouches including deferring separating the cushions to a later time. Moreover, storage in the bin 84 or other storage device may be unnecessary particularly if the packaging cushions are to be used immediately.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A packaging cushion comprising:
a pouch that defines a hollow interior space, the pouch being made of a paper material;
a fill material contained within the hollow interior space of the pouch, the fill material comprising loose, used packaging material.

2. The packaging cushion of claim 1, wherein the paper material comprise kraft paper.

3. The packaging cushion of claim 1, wherein the used packaging material comprises used corrugated cardboard.

4. The packaging cushion of claim 3, wherein at least a portion of the used corrugated cardboard is shredded.

5. The packaging cushion of claim 1, wherein the pouch comprises two sheets of paper that are joined together.

6. The packaging cushion of claim 5, wherein the two sheets of paper are joined together by an adhesive material.

7. The packaging cushion of claim 1, wherein the paper material has a weight of between approximately 20 lbs and approximately 60 lbs.

8. A method of recycling used packaging material into a packaging cushion comprising the steps of:
collecting used packaging material;
shredding at least a portion of the collected used packaging material to form a fill material;
forming a pouch using paper material;
filling the paper pouch with the fill material; and
closing the paper pouch to form the packaging cushion.

9. The method of claim 8 further including the step of separating the packaging cushion from another packaging cushion.

10. The method of claim 8, wherein the step of closing the paper pouch comprises sealing the paper pouch with an adhesive material.

11. The method of claim 8, wherein the step of forming the pouch comprises supplying first and second sheets of paper.

12. The method of claim 11, wherein the step of closing the paper pouch comprises joining the first and second sheets of paper together.

13. The method of claim 11, wherein the used packaging material comprises used corrugated cardboard.

14. A packaging cushion assembly system comprising:
a corrugated cardboard shredder;
a shredded cardboard storage hopper for received shredded corrugated cardboard from the shredder;
a fill chute configured and oriented to direct shredded corrugated cardboard from the storage hopper to a pouch-forming zone;
a first and second paper rolls;
feed rollers for directing paper from the first and second paper rolls to the pouch forming zone; and
forming rollers for bringing paper from the first and second paper rolls into back-to-back relation in the pouch forming zone to form a pouch.

15. The packaging cushion assembly system of claim 14 further including a cutting station for separating a completed packaging cushion from a trailing pouch.

16. The packing cushion assembly system of claim 14 wherein an adhesive is applied to at least one side of paper supplied by at least one of the first and second paper rolls.
